(19) United States
(12) Patent Application Publication
(10) Pub. No.: US 2017/0058816 A1
(43) Pub. Date: Mar. 2, 2017

(54) CONTROL APPARATUS OF ENGINE

(71) Applicant: Mazda Motor Corporation, Aki-gun (JP)

(72) Inventors: Yuichiro Tsumura, Aki-gun (JP); Keitaro Ezumi, Hiroshima-shi (JP)

(21) Appl. No.: 15/240,904

(22) Filed: Aug. 18, 2016

(30) Foreign Application Priority Data
Sep. 2, 2015 (JP) 2015-173128

(51) Int. Cl. F02D 41/30; F02D 41/00; F02B 11/02

(52) U.S. Cl. CPC F02D 41/3064; F02B 11/02; F02D 41/0085; F02D 2200/1002

(57) ABSTRACT

A control apparatus that is applied to a gasoline engine including cylinders is provided, which includes a controller for controlling the engine to perform a compression self-ignition operation within a first operating range, and perform a forced-ignition operation within a second operating range. Within a third operating range where an engine load is above the first range and below the second range, the controller executes a combined operation control in which a first cylinder performs the compression self-ignition operation and a second cylinder performs the forced-ignition operation, and the controller causes a change rate of a torque from the first cylinder to be lower than that of a torque from the second cylinder, the rates being taken in relation to a change of a requested load of the engine, the first cylinder being one or some of the cylinders, the second cylinder being the rest of the cylinders.

### BACKGROUND

The present invention relates to a control apparatus of an engine, particularly to a control apparatus of an engine which is applied to a gasoline engine including a plurality of cylinders.

Generally, a spark-ignition method using an ignition plug for ignition is broadly adopted for engines which use gasoline or fuel containing gasoline as a main component. Recently, in view of improving fuel efficiency, arts have been developed, in which a high geometric compression ratio is applied to an engine and a premixed charge compression self-ignition, which is referred to as a compression self-ignition (specifically, HCCI (Homogeneous-Charge Compression Ignition)), is performed within a predetermined engine operating range by using gasoline or fuel containing gasoline as a main component.

For example, JP2004-239217A discloses such an engine which performs the compression self-ignition. In JP2004-239217A, the engine is a multi-cylinder engine and an art is disclosed in which, when switching a combustion mode of the engine from a spark-ignition operation (an operation in which a mixture gas is spark-ignited) to a compression self-ignition operation (an operation in which the mixture gas is compressed to self-ignite), the switch is performed on one or some of the plurality of cylinders at a time.

Generally, in gasoline engines in which a compression self-ignition is performed, the compression self-ignition operation (hereinafter, suitably referred to as the “CI operation”) is performed within a predetermined low load range of the engine, and the spark-ignition operation (hereinafter, suitably referred to as the “SI operation”) is performed within a predetermined high load range of the engine. In the CI operation, although fuel efficiency is high, a speed of combustion sharply increases when the engine load becomes high, and as a result, combustion noise occurs and a control of an ignition timing becomes difficult. Therefore, when the engine load exceeds a predetermined value, the combustion mode is switched from the CI operation to the SI operation. However, within an engine operating range where the switch is performed, performing the SI operation would degrade the fuel efficiency. This is because, although a high fuel efficiency is obtained by the SI operation when the engine load is high to a certain extent, the engine load corresponding to the operating range where the switch is performed is lower than a lowest load above which the high fuel efficiency is obtained by the SI operation.

### SUMMARY

The present invention is made in view of solving the situations of the conventional art described above, and aims to provide a control apparatus of an engine, which is capable of suitably improving a fuel efficiency within an engine operating range where a compression self-ignition operation and a forced-ignition operation are switched therebetween.

According to one aspect of the present invention, a control apparatus that is applied to a gasoline engine including a plurality of cylinders is provided. The apparatus includes a controller for controlling the engine to perform a compression self-ignition operation within a first operating range of the engine where an engine load is lower than a predetermined value, and perform a forced-ignition operation within a second operating range of the engine where the engine load is above the first operating range, the compression self-ignition operation being an operation in which the engine is operated by compressing a mixture gas containing fuel to self-ignite, the forced-ignition operation being an operation in which the engine is operated by forcibly igniting the mixture gas. Within a third operating range of the engine where the engine load is above the first operating range and below the second operating range, the controller executes a combined operation control in which a first cylinder performs the compression self-ignition operation and a second cylinder performs the forced-ignition operation, and the controller causes a change rate of a torque generated by the first cylinder to be lower than a change rate of a torque generated by the second cylinder, each of the change rates being taken in relation to a change of a requested load of the engine, the first cylinder being one or some of the plurality of cylinders, the second cylinder being in a remainder (i.e., the rest) of the plurality of cylinders.

According to this configuration, within the third operating range, the first cylinder performs the compression self-ignition operation to gradually change the torque, and the second cylinder performs the forced-ignition operation to greatly change the torque. Therefore, fuel efficiency can be improved while satisfying a requested torque (requested load).

Specifically, normally the fuel efficiency degrades if the forced-ignition operation is performed within the third operating range (medium-low load range). However, within such a third operating range, since the first cylinder performs the compression self-ignition operation to gradually change the torque, by greatly changing the torque generated by the second cylinder so as to satisfy the requested torque, the torque at which a high fuel efficiency is obtained by the forced-ignition operation can swiftly be applied from the second cylinder. For example, when the requested load of the engine increases, by greatly increasing the torque generated by the second cylinder so as to satisfy the requested load, the load can swiftly reach a medium-high load range where the high fuel efficiency is obtained by the forced-ignition operation. Therefore, according to the above configuration, the fuel efficiency in the forced-ignition operation performed within the third operating range can be improved.

On the other hand, normally it is not suitable to perform the compression self-ignition operation within the third operating range. However, within such a third operating range, since the second cylinder performs the forced-ignition operation to greatly change the torque as described above, by gradually changing the torque generated by the first cylinder so as to satisfy the requested torque, the suitable compression self-ignition operation in which a combustion noise reduction, a controllability of an igniting timing, etc. are secured, can be achieved. Thus, within the third operating range, the high fuel efficiency in the compression self-ignition operation can suitably be obtained.

As described above, according to the configuration, by performing both the compression self-ignition and forced-ignition operations within the third operating range and suitably controlling the torques generated therein, the fuel efficiency of the engine as a whole can be improved while satisfying the requested torque.

The controller may cause the torque generated by the first cylinder to be the same as or lower than a torque thereof before the combined operation control, and the controller may increase the torque generated by the second cylinder to be higher than a torque thereof before the combined operation control.

According to this configuration, by causing the torque generated by the first cylinder to be the same as or lower than the torque thereof before the control, the combustion noise reduction, the controllability of the igniting timing, etc. can be secured for the first cylinder more effectively during the combined operation control. Further, by increasing the torque generated by the second cylinder to be higher than the torque thereof before the control, the torque at which the high fuel efficiency is obtained by the forced-ignition operation can more swiftly be applied from the second cylinder. Thus, the fuel efficiency of the engine as a whole can be improved.

In a period around the timing of executing the combined operation control, the controller may substantially fix the torque generated by the first cylinder.

According to this configuration, since the torque generated by the first cylinder is substantially fixed in the period around the timing of executing the control, during the combined operation control, a controllability of a combustion phase can suitably be secured.

The controller may cause both the first and second cylinders to perform combustion at a theoretical air-fuel ratio.

According to this configuration, by causing both the first and second cylinders to perform the combustion at the theoretical air-fuel ratio (λ=1), exhaust gas from either of the first and second cylinders achieves the theoretical air-fuel ratio, and the exhaust gas at the theoretical air-fuel ratio can be supplied to an exhaust emission control catalyst (e.g., a three-way catalyst). Thus, NOₓ contained within the exhaust gas discharged from the second cylinder can suitably be purified by the catalyst.

In a case where the controller causes the plurality of cylinders of the engine to operate in a predetermined combustion order, the controller may cause the first and second cylinders to alternately perform combustion.

According to this configuration, when the plurality of cylinders are operated in the predetermined combustion order, by causing the first and second cylinders to alternately perform the combustion, an engine vibration caused by a difference between the torque generated by the first cylinder and the torque generated by the second cylinder can suitably be reduced. Specifically, a cycle of switching the torque generated by the first cylinder and the torque generated by the second cylinder therebetween is designed to be short, as a result, the engine vibration can be less easily felt.

The controller may cause an average torque of the torque generated by the first cylinder and the torque generated by the second cylinder, to match with a requested torque corresponding to the requested load of the engine.

According to this configuration, since the average torque of the torque generated by the first cylinder and the torque generated by the second cylinder is matched with the requested torque corresponding to the requested load of the engine, the requested torque can reliably be satisfied during the combined operation control.

### BRIEF DESCRIPTION OF THE DRAWINGS

FIG. 1 is a view illustrating a schematic configuration of an engine to which a control apparatus according to one embodiment of the present invention is applied.

FIG. 2 is a block diagram illustrating an electric configuration regarding the control apparatus of the engine according to the embodiment of the present invention.

FIG. 3 is a chart illustrating operating ranges of the engine according to the embodiment of the present invention.

FIG. 4 is a view illustrating operations of an intake valve and an exhaust valve within a first operating range according to the embodiment of the present invention.

FIG. 5 is a view illustrating operations of the intake valve and the exhaust valve within a second operating range according to the embodiment of the present invention.

FIG. 6 is a view illustrating a combined operation control according to the embodiment of the present invention.

FIG. 7 is a view illustrating a control executed when a requested load is slightly increased from a highest load within the first operating range and the operating range shifts to a third operating range according to the embodiment of the present invention.

FIG. 8 is a view illustrating fuel efficiency when the combined operation control is executed according to the embodiment of the present invention.

FIG. 9 is a time chart illustrating a first example of the combined operation control according to the embodiment of the present invention.

FIG. 10 is a time chart illustrating a second example of the combined operation control according to the embodiment of the present invention.

FIG. 11 is a time chart illustrating a third example of the combined operation control according to the embodiment of the present invention.

### DETAILED DESCRIPTION OF EMBODIMENT

Hereinafter, a control apparatus of an engine according to one embodiment of the present invention is described with reference to the appended drawings.

### Apparatus Configuration

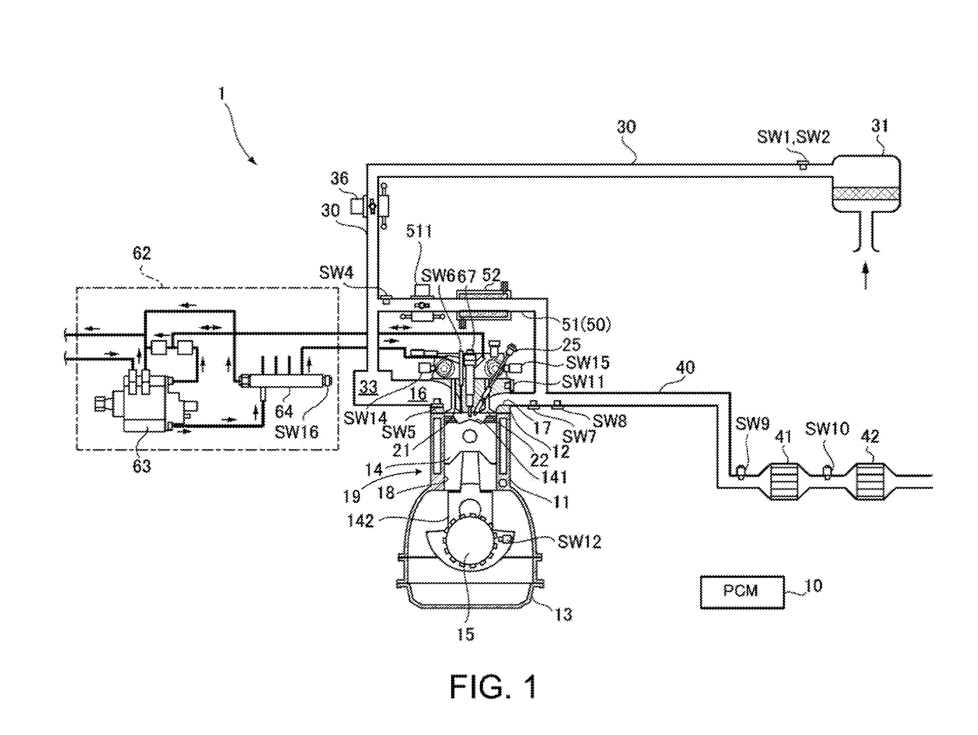

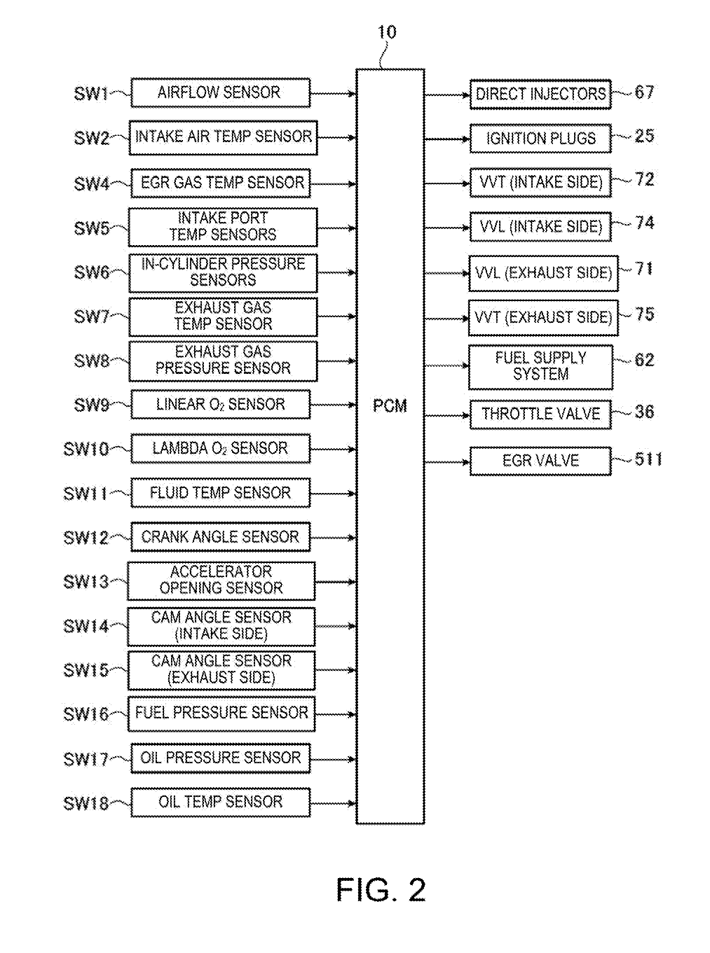

FIG. 1 is a view illustrating a schematic configuration of an engine 1 to which a control apparatus according to one embodiment of the present invention is applied. FIG. 2 is a block diagram illustrating the control apparatus of the engine according to the embodiment of the present invention.

The engine 1 is a gasoline engine that is mounted on a vehicle and supplied with fuel containing at least gasoline. The engine 1 includes a cylinder block 11 provided with a plurality of cylinders 18 (note that although only one cylinder is illustrated in FIG. 1, for example, four cylinders are linearly provided in this embodiment), a cylinder head 12 disposed on the cylinder block 11, and an oil pan 13 disposed below the cylinder block 11 and storing a lubricant. A reciprocatable piston 14 coupled to a crankshaft 15 via a connecting rod 142 is fitted into each of the cylinders 18. A cavity 141 having a reentrant shape, such as a shape generally used in a diesel engine, is formed on a top face of each piston 14. When the piston 14 is at a position near a top dead center on compression stroke (CTDC), the cavity 141 opposes to an injector 67 described later. The cylinder head 12, the cylinders 18, and the pistons 14 formed with the respective cavities 141 define combustion chambers 19. Note that the shape of each combustion chamber 19 is not limited to the shape in the drawings. For example, the shape of the cavity 141, the shape of the top face of the piston 14, and the shape of a ceiling part of the combustion chamber 19 may suitably be changed.

A geometric compression ratio of the engine 1 is set to be 15:1 or higher, which is comparatively high, so as to improve a theoretical thermal efficiency, stabilize a compression ignition combustion (described later), etc. Note that the geometric compression ratio may suitably be set within a range about between 15:1 and 20:1.

In the cylinder head 12, each of the cylinders 18 is formed with an intake port 16 and an exhaust port 17 and provided with an intake valve 21 for opening and closing the intake port 16 on the combustion chamber 19 side and an exhaust valve 22 for opening and closing the exhaust port 17 on the combustion chamber 19 side.

In a valve train of the engine 1 for operating the intake and exhaust valves 21 and 22, for example, a hydraulically-actuated variable valve lift mechanism (see FIG. 2, and hereinafter, referred to as the VVL (Variable Valve Lift)) 71 for switching an operation mode of the exhaust valve 22 between a normal mode and a special mode, and a variable phase mechanism (hereinafter, referred to as the VVT (Variable Valve Timing)) 75 for changing a rotational phase of an exhaust camshaft in relation to the crankshaft 15, are provided on an exhaust side. The VVL 71 (detailed structure thereof is not illustrated) includes two kinds of cams with different profiles in which a first cam has one cam nose and a second cam has two cam noses, and a cam shifting mechanism for selectively transmitting an operating state of one of the first and second cams to the exhaust valve 22. While the cam shifting mechanism transmits the operating state of the first cam to the exhaust valve 22, the exhaust valve 22 operates in the normal mode (where it opens only once during exhaust stroke). On the other hand, while the cam shifting mechanism transmits the operating state of the second cam to the exhaust valve 22, the exhaust valve 22 operates in the special mode (where it opens once during the exhaust stroke and once more during intake stroke), which is a so-called exhaust open-twice control. The VVL 71 switches the normal and special modes therebetween according to an operating state of the engine. Specifically, the special mode is utilized for a control regarding an internal Exhaust Gas Recirculation (EGR). Note that an electromagnetic valve train for operating the exhaust valve 22 by an electromagnetic actuator may be adopted.

For the VVT 75, any known structures of hydraulic, electromagnetic and mechanical types may suitably be adopted, for which illustration of a detailed structure is omitted. Opening and closing timings of the exhaust valve 22 are variable within a predetermined range by the VVT 75. Further, the lifts and operation timings of the exhaust valves 22 provided for the respective cylinders 18 are controlled per cylinder 18 by the VVL 71 and the VVT 75.

Note that the internal EGR is not limited to be achieved by the exhaust open-twice control only. For example, an internal EGR control by an intake open-twice control in which the intake valve 21 opens twice may be executed, or an internal EGR control in which a negative overlap period during which both the intake and exhaust valves 21 and 22 are closed on one of the exhaust stroke and the intake stroke is provided to leave burned gas inside the cylinder 18 may be executed.

Similarly to the exhaust side of the valve train including the VVL 71 and the VVT 75, an intake side of the valve train includes a VVL 74 and a VVT 72 as illustrated in FIG. 2. The VVL 74 on the intake side is different from the VVL 71 on the exhaust side. The VVL 74 on the intake side includes two kinds of cams with different profiles in which a high lift cam relatively increases the lift of the intake valve 21 and a low lift cam relatively reduces the lift of the intake valve 21, and a cam shifting mechanism for selectively transmitting an operating state of one of the large and low lift cams to the intake valve 21. While the VVL 74 transmits the operating state of the high lift cam to the intake valve 21, the intake valve 21 opens with a relatively high lift, and an open period thereof is long. On the other hand, while the VVL 74 transmits the operating state of the low lift cam to the intake valve 21, the intake valve 21 opens with a relatively low lift, and the open period thereof is short. The high lift cam and the low lift cam are designed to switch therebetween while synchronizing closing timings or opening timings thereof with each other.

Also for the VVT 72 on the intake side, similarly to the VVT 75 on the exhaust side, any known structures of hydraulic, electromagnetic and mechanical types may suitably be adopted, for which illustration of a detailed structure is omitted. Opening and closing timings of the intake valve 21 are also variable within a predetermined range by the VVT 72. Further, the lifts and operation timings of the intake valves 21 provided for the respective cylinders 18 are controlled per cylinder 18 by the VVL 74 and the VVT 72. Note that it may be such that the VVL 74 is omitted and only the VVT 72 is applied on the intake side, so that only the opening and closing timings of the intake valve 21 are changed.

The (direct) injector 67 for directly injecting the fuel into the cylinder 18 is attached to the cylinder head 12 for each cylinder 18. The injector 67 is arranged so that its nozzle hole is oriented toward an inside of the combustion chamber 19 from a center portion of a ceiling surface of the combustion chamber 19. The injector 67 directly injects into the combustion chamber 19 an amount of fuel corresponding to the operating state of the engine 1 at an injection timing designed according to the operating state of the engine 1. In this embodiment, the injector 67 (a detailed structure is not illustrated) is a multi-hole injector formed with a plurality of nozzle holes. Thus, the injector 67 injects the fuel so that the fuel spray spreads radially from the center portion of the combustion chamber 19. At a timing when the piston 14 is near the CTDC, the fuel spray injected to spread radially from the center portion of the combustion chamber 19 flows along a wall surface of the cavity 141 formed in the piston top face. Therefore, it may be said that the cavity 141 is formed to contain therewithin the fuel spray injected at the timing when the piston 14 is near the CTDC. The combination of the multi-hole injector 67 and the cavity 141 is advantageous in, after the fuel is injected, shortening a mixture gas forming period and a combustion period. Note that the injector 67 is not limited to the multi-hole injector, and may be an outward opening valve type injector.

A fuel tank (not illustrated) is coupled to the injectors 67 via a fuel supply path. A fuel supply system 62 having a fuel pump 63 and a common rail 64 and for supplying the fuel to each injector 67 at a comparatively high fuel pressure is provided on the fuel supply path. The fuel pump 63 feeds the fuel from the fuel tank to the common rail 64, and the common rail 64 is capable of accumulating the fed fuel at a comparatively high fuel pressure. By opening the nozzle holes of the injector 67, the fuel accumulated in the common rail 64 is injected from the nozzle holes of the injector 67. Here, the fuel pump 63 is a plunger-type pump (not illustrated) and is driven by the engine 1. The fuel supply system 62 including the engine-driven pump enables the supply of the fuel to the injector 67 at a high fuel pressure of 30 MPa or above. A highest value of the fuel pressure may be about 120 MPa. The pressure of the fuel supplied to the injector 67 is changed according to the operating state of the engine 1. Note that the fuel supply system 62 is not limited to the above configuration.

Further, an ignition plug 25 for forcibly igniting (specifically, igniting by spark) the mixture gas within the combustion chamber 19 is attached to the cylinder head 12 for each cylinder 18. In this embodiment, the ignition plug 25 is arranged penetrating the cylinder head 12 so as to extend obliquely downward from the exhaust side of the engine 1. The ignition plug 25 is arranged so that its tip is oriented toward the inside of the cavity 141 of the piston 14 at the CTDC.

On one side surface of the engine 1, as illustrated in FIG. 1, an intake passage 30 is connected to communicate with the intake ports 16 of the respective cylinders 18. On the other side surface of the engine 1, an exhaust passage 40 is connected to guide out the burned gas (exhaust gas) discharged from the combustion chambers 19 of the respective cylinders 18.

An air cleaner 31 for filtrating intake air is disposed in an upstream end part of the intake passage 30, and a throttle valve 36 for adjusting an intake air amount to the cylinders 18 is disposed downstream of the air cleaner 31. Further, a surge tank 33 is disposed near a downstream end of the intake passage 30. A part of the intake passage 30 downstream of the surge tank 33 is branched into independent passages extending toward the respective cylinders 18, and downstream ends of the independent passages are connected with the intake ports 16 of the cylinders 18, respectively.

An upstream part of the exhaust passage 40 includes an exhaust manifold. The exhaust manifold has independent passages branched toward the respective cylinders 18 and connected with respective external ends of the exhaust ports 17, and a manifold section where the independent passages are collected together. In a part of the exhaust passage 40 downstream of the exhaust manifold, a direct catalyst 41 and an underfoot catalyst 42 are connected as an exhaust emission control device for purifying hazardous components contained within the exhaust gas. Each of the direct catalyst 41 and the underfoot catalyst 42 includes a cylindrical case and, for example, a three-way catalyst disposed on a flow path within the case.

A portion of the intake passage 30 between the surge tank 33 and the throttle valve 36 is connected with a part of the exhaust passage 40 upstream of the direct catalyst 41, via an EGR passage 50 for recirculating a part of the exhaust gas back to the intake passage 30. The EGR passage 50 includes a main passage 51 provided with an EGR cooler 52 for cooling the exhaust gas by an engine coolant. The main passage 51 is provided with an EGR valve 511 for adjusting a recirculation amount of the exhaust gas to the intake passage 30.

The engine 1 is controlled by a powertrain control module (hereinafter, may be referred to as the PCM) 10. The PCM 10 is comprised of a microprocessor including a CPU, a memory, a counter timer group, an interface, and paths for connecting these units. The PCM 10 configures a controller.

As illustrated in FIGS. 1 and 2, detection signals of various kinds of sensors SW1, SW2, and SW4 to SW18 are inputted to the PCM 10. Specifically, the PCM 10 receives a detection signal of an airflow sensor SW1 for detecting a flow rate of fresh air on the downstream side of the air cleaner 31, a detection signal of an intake air temperature sensor SW2 for detecting a temperature of the fresh air, a detection signal of an EGR gas temperature sensor SW4 disposed near a connecting part of the EGR passage 50 with the intake passage 30 and for detecting a temperature of external EGR gas, detection signals of intake port temperature sensors SW5 attached to the intake ports 16 and for detecting temperatures of the intake air immediately before flowing into the cylinders 18, respectively, detection signals of in-cylinder pressure sensors SW6 attached to the cylinder head 12 and for detecting pressures inside the cylinders 18, respectively, detection signals of an exhaust gas temperature sensor SW7 and an exhaust gas pressure sensor SW8 that are disposed near a connecting part of the exhaust passage 40 with the EGR passage 50 and for detecting exhaust gas temperature and pressure, respectively, a detection signal of a linear O₂ sensor SW9 disposed upstream of the direct catalyst 41 and for detecting an oxygen concentration within the exhaust gas, a detection signal of a lambda O₂ sensor SW10 disposed between the direct catalyst 41 and the underfoot catalyst 42 and for detecting the oxygen concentration within the exhaust gas, a detection signal of a fluid temperature sensor SW11 for detecting a temperature of the engine coolant, a detection signal of a crank angle sensor SW12 for detecting a rotational angle of the crankshaft 15, a detection signal of an accelerator opening sensor SW13 for detecting an accelerator opening corresponding to an angle (operation amount) of an acceleration pedal (not illustrated) of the vehicle, detection signals of intake and exhaust cam angle sensors SW14 and SW15, a detection signal of a fuel pressure sensor SW16 attached to the common rail 64 of the fuel supply system 62 and for detecting the pressure of the fuel supplied to the injector 67, a detection signal of an oil pressure sensor SW17 for detecting an oil pressure of the engine 1, and a detection signal of an oil temperature sensor SW18 for detecting an oil temperature of the engine 1.

By performing various kinds of operations based on these detection signals, the PCM 10 determines the state of the engine 1 and further the state of the vehicle, and outputs control signals to the (direct) injectors 67, the ignition plugs 25, the VVT 72 and the VVL 74 on the intake side, the VVT 75 and the VVL 71 on the exhaust side, the fuel supply system 62, and the actuators of the various kinds of valves (the throttle valve 36 and the EGR valve 511) according to the determined state. In this manner, the PCM 10 operates the engine 1. Although described later in detail, the PCM 10 may be referred to as the controller of the engine, and together with the various sensors providing input and the VVTs, VVLs, etc. provided with output as shown in FIG. 2, may form the control apparatus. It will be appreciated that the controller includes a processor and associated volatile working memory and non-volatile storage memory for storing program instructions that when implemented by the processor, perform the functions discussed herein.

### Operating Range

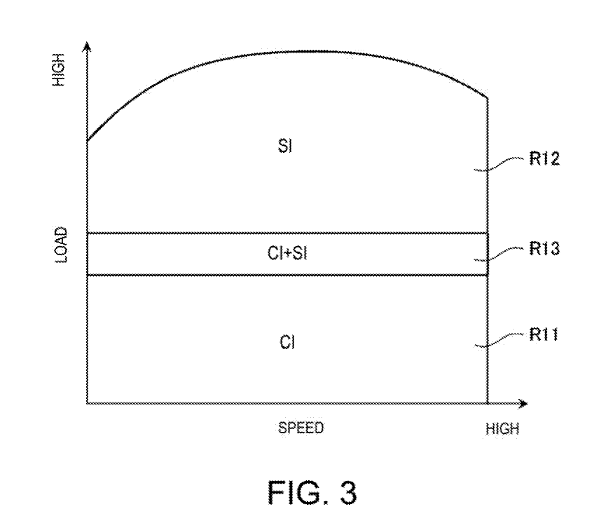

Next, operating ranges of the engine according to this embodiment are described with reference to FIG. 3. FIG. 3 illustrates one example of an operation control map of the engine 1 in this embodiment. Within a first operating range R11 where an engine load is relatively low, to improve a fuel efficiency and exhaust emission performance, the engine 1 does not perform ignition by the ignition plug 25, but performs the compression ignition combustion triggered by the compression self-ignition in each cylinder 18. However, as the engine load increases, a speed of the combustion becomes excessively high with the compression ignition combustion, and thus, combustion noise may occur and a control of an ignition timing may become difficult (misfire tends to occur). Therefore, with the engine 1, within a second operating range R12 where the engine load is relatively high, forced-ignition combustion (here, spark-ignition combustion) using the ignition plug 25 is performed in each cylinder 18 instead of the compression ignition combustion. As described above, with the engine 1, the combustion mode is switched between a CI (Compression Ignition) operation in which an operation by the compression ignition combustion is performed and an SI (Spark Ignition) operation in which an operation by the spark-ignition combustion is performed, according to the operating state of the engine 1, particularly the load of the engine 1.

Particularly in this embodiment, a third operating range R13 is further defined between the first operating range R11 where the CI operation is performed and the second operating range R12 where the SI operation is performed. In other words, the third operating range R13 is defined as a medium load range where the engine load is above the first operating range R11 and below the second operating range R12. Within the third operating range R13, both the CI operation and the SI operation are performed. Specifically, in this embodiment, when the engine load is within the third operating range R13, the PCM 10 executes a combined operation control in which one or some of all the cylinders 18 of the engine 1 perform the CI operation and a reminder (i.e., the rest) of all the cylinders 18 perform the SI operation.

A boundary between the third operating range R13 and the first operating range R11 therebelow is preferably defined based on a load at or above which the combustion noise may occur and the control of the ignition timing may become difficult if the CI operation is performed. Further, a boundary between the third operating range R13 and the second operating range R12 thereabove is preferably defined based on a load below which the high fuel efficiency cannot be obtained by the SI operation, whereas at or above which the high fuel efficiency can be obtained by the SI operation.

Hereinafter, the CI operation which is performed within the first operating range R11 and the SI operation which is performed within the second operating range R12 are specifically described.

Within a low segment of the first operating range R11, in the CI operation, the VVL 71 on the exhaust side is turned on, the exhaust open-twice control (the exhaust valve 22 is opened also on the intake stroke) is executed, and the internal EGR gas at a relatively high temperature (hot EGR gas) is introduced into each cylinder 18, so as to increase a temperature inside the cylinder 18 at an end of the compression stroke in order to improve ignitability and stability of the compression ignition combustion. Further in the CI operation, within the low segment of the first operating range R11, the fuel is injected into the cylinder 18 by the injector 67 at least in a period from the intake stroke to a middle stage of the compression stroke, so as to form a homogeneous mixture gas. In this case, the fuel may be split into a plurality of injections on the intake and compression strokes (split injections).

On the other hand, within a high segment of the first operating range R11, in the CI operation, since a temperature environment inside the cylinder 18 increases, the internal EGR gas amount is reduced and the external EGR gas cooled by passing through the EGR cooler 52 (cooled EGR gas) is introduced into the cylinder 18, so as to prevent pre-ignition. Further, to stabilize the compression ignition combustion while avoiding abnormal combustion (e.g., pre-ignition), in addition to the above temperature control inside the cylinder 18, the fuel is injected into the cylinder 18 at a significantly increased fuel pressure at least in a period from a late stage of the compression stroke to an initial stage of expansion stroke (high-pressure retarded injection).

While the CI operation is performed within the first operating range R11 as above, in the SI operation within the second operating range R12, the VVL 71 on the exhaust side is turned off and the hot EGR gas introduction is suspended, whereas the cooled EGR gas introduction is continued. Further in the SI operation, the throttle valve 36 is fully opened and an opening of the EGR valve 511 is adjusted to control the amounts of fresh air and the external EGR gas introduced into the cylinder 18. The above adjustment of the ratio of gas introduced into the cylinder 18 leads to reducing a pumping loss. Additionally, the abnormal combustion is avoided by introducing a large amount of the cooled EGR gas into the cylinder 18, and generation of Raw NOₓ and a cooling loss are reduced by lowering a combustion temperature of the spark-ignition combustion. Note that, within a full load range, the EGR valve 511 is closed to reduce the amount of the external EGR gas to zero.

Moreover in the SI operation, the high-pressure retarded injection is performed to avoid abnormal combustion (e.g., pre-ignition and knocking). Specifically, the high-pressure retarded injection in which the fuel is injected into each cylinder 18 at a high fuel pressure of 30 MPa or above is performed in the retarding period from the late stage of the compression stroke to the initial stage of the expansion stroke. Note that, in the SI operation, in addition to the high-pressure retarded injection performed in the retarding period, a part of the fuel for one combustion cycle may be injected into the cylinder 18 in an intake stroke period in which the intake valve 21 is opened (i.e., split injections may be performed).

### Control of Intake and Exhaust Valves

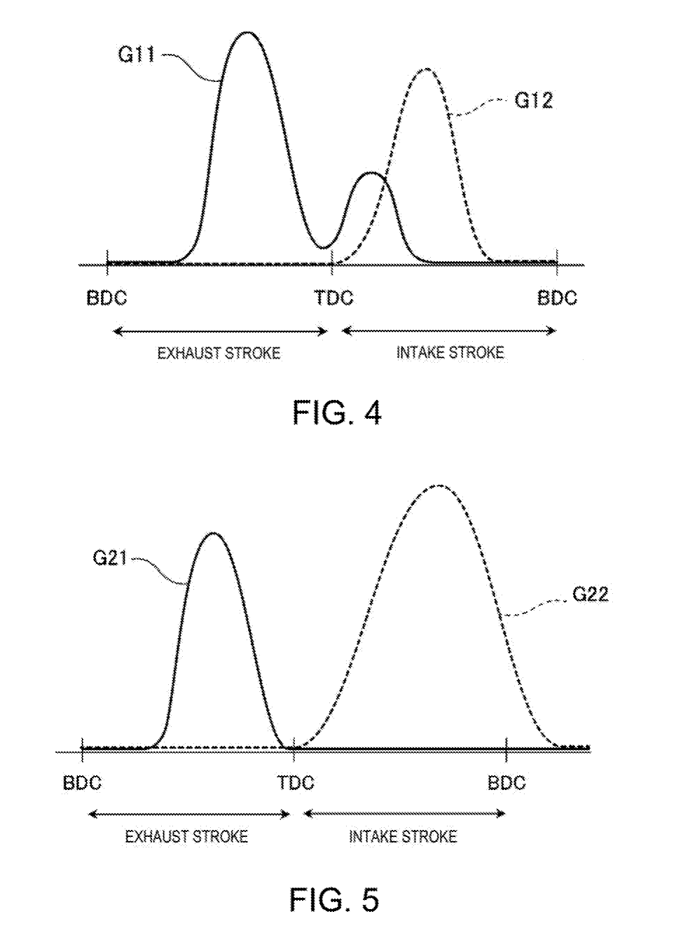

Next, a specific example of a control of the intake and exhaust valves 21 and 22 according to this embodiment is described with reference to FIGS. 4 and 5. FIG. 4 illustrates operations of the intake and exhaust valves 21 and 22 within the first operating range R11 where the CI operation is performed, and FIG. 5 illustrates operations of the intake and exhaust valves 21 and 22 within the second operating range R12 where the SI operation is performed. In FIGS. 4 and 5, the horizontal direction indicates the crank angle, charts G11 and G21 in solid lines indicate the operations of the exhaust valve 22 corresponding to the crank angle, and charts G12 and G22 in dashed lines indicate the operations of the intake valve 21 corresponding to the crank angle. As described above, the intake valve 21 is controlled in its opening and closing timings and lift by the PCM 10 through the VVT 72 and the VVL 74, and the exhaust valve 22 is controlled in its opening and closing timings and lift by the PCM 10 through the VVT 75 and the VVL 71.

As illustrated in FIG. 4, within the first operating range R11 where the CI operation is performed, the exhaust open-twice control (the exhaust valve 22 is opened on the exhaust stroke and the intake stroke) is executed (see the chart G11 in the solid line), so as to introduce the internal EGR gas at the relatively high temperature into the cylinder 18. On the other hand, as illustrated in FIG. 5, within the second operating range R12 where the SI operation is performed, the exhaust valve 22 is only opened on the exhaust stroke (see the chart G21 in the solid line). Particularly within the second operating range R12, the intake valve 21 is opened earlier but closed later than in the CI operation, and the lift of the intake valve 21 is increased higher than in the CI operation (see the chart G22 in the dashed line), that is, a so-called Miller cycle is achieved.

### Combined Operation Control

Next, the combined operation control of this embodiment is described.

First, the combined operation control of this embodiment is briefly described. In this embodiment, within the third operating range R13 where the engine load is above the first operating range R11 and below the second operating range R12 (see FIG. 3), the PCM 10 executes the combined operation control in which the one or some of all the cylinders 18 of the engine 1 perform the CI operation and the rest of all the cylinders 18 perform the SI operation. For example, in a case of applying a four-cylinder engine, two of the cylinders 18 perform the CI operation and the other two cylinders 18 perform the SI operation, or three of the cylinders 18 perform the CI operation and the other cylinder 18 performs the SI operation, further alternatively, one of the cylinders 18 performs the CI operation and the other three cylinders 18 perform the SI operation.

In this case, when a requested load of the engine 1 is increased and the operating range shifts from the first operating range R11 to the third operating range R13, the PCM 10 causes one or some of all the cylinders 18 which have been performing the CI operation within the first operating range R11 to continue the CI operation, and causes the rest of all the cylinders 18 to switch from the CI operation to the SI operation. On the other hand, when the requested load of the engine 1 is reduced and the operating range shifts from the second operating range R12 to the third operating range R13, the PCM 10 causes one or some of all the cylinders 18 which have been performing the SI operation within the second operating range R12 to continue the SI operation, and causes the rest of all the cylinders 18 to switch from the SI operation to the CI operation. Hereinafter, each cylinder which performs the CI operation in the combined operation control is suitably referred to as the “CI cylinder” and each cylinder which performs the SI operation in the combined operation control is suitably referred to as the “SI cylinder.”

Note that specific contents of the controls in the CI and SI operations are described in the section [Operating Range] above.

Particularly in this embodiment, in the case of executing the combined operation control described above, the PCM 10 causes a change rate of a torque generated by the CI cylinder 18, to be lower than a change rate of a torque generated by the SI cylinder 18. The change rate of the torque is taken in relation to a change of the requested load of the engine 1. Specifically, when the requested load of the engine 1 is increased and the operating range shifts from the first operating range R11 to the third operating range R13, and when the engine load increases within the third operating range R13, the PCM 10 causes an inclination of the increase of the torque from the CI cylinder 18 to be gentler than that of the torque from the SI cylinder 18 (the torque generated by the CI cylinder may be reduced or fixed instead of being increased). On the other hand, when the requested load of the engine 1 is reduced and the operating range shifts from the second operating range R12 to the third operating range R13, and when the engine load decreases within the third operating range R13, the PCM 10 causes an inclination of the reduction of the torque from the CI cylinder 18 to be gentler than that of the torque from the SI cylinder 18 (the torque generated by the CI cylinder may be increased or fixed instead of being reduced).

Moreover in this embodiment, the PCM 10 causes the torque from the CI cylinder 18 to be the same as or lower than the torque before the combined operation control, and causes the torque from the SI cylinder 18 to be higher than the torque before the combined operation control. For example, immediately after the combined operation control is started, the PCM 10 reduces, in a substantially stepwise fashion, the torque from the CI cylinder 18 and increases, in a substantially stepwise fashion, the torque from the SI cylinder 18. Then, the PCM 10 gradually changes the torque from the CI cylinder 18 while greatly changing the torque from the SI cylinder 18.

The following is the reason for performing such a combined operation control.

In the CI operation, although the fuel efficiency is high, the speed of the combustion becomes high when the engine load becomes high, and as a result, the combustion noise may occur and the control of the ignition timing may become difficult. Therefore, conventionally, the CI operation is performed only within the first operating range R11 where the engine load is relatively low, and when the engine load exceeds the first operating range R11, the combustion mode is switched from the CI operation to the SI operation. However, within an operating range (medium-low load range) where the engine load is slightly above the first operating range R11, the fuel efficiency degrades if the SI operation is performed. This is because, although the high fuel efficiency can be obtained by the SI operation within an operating range where the engine load is high to a certain extent (medium-high load range), the high fuel efficiency cannot be obtained within the operating range where the engine load is slightly above the first operating range R11 (medium-low load range).

Therefore, in this embodiment, the medium-low load range, specifically, an operating range where the high fuel efficiency cannot be obtained by the SI operation even though the SI operation is supposed to be operated instead of the CI operation due to the properties of the CI operation (in the conventional case, corresponding to a low segment of an operating range where only the SI operation is performed, which is a low segment of the predetermined high load range) is defined as the third operating range R13, separately from the first and second operating ranges R11 and R12. Further in this embodiment, the combined operation control in which one or some of all the cylinders 18 perform the CI operation and the rest of all the cylinders 18 perform the SI operation is executed within the third operating range R13, and the change rate of the torque from the CI cylinder 18 is reduced to be lower than that of the torque from the SI cylinder 18.

Thus, with the CI cylinder 18, fuel efficiency is improved by the CI operation, and the torque is gradually changed to secure a reduction of the combustion noise, the controllability of the igniting timing, etc. Further, with the SI cylinder 18, the torque is greatly changed so that a torque with which the high fuel efficiency can be obtained by the SI operation is swiftly applied, and the fuel efficiency is improved. Particularly, in this embodiment, the torque from the CI cylinder 18 is caused to be the same as or lower than the torque before the combined operation control and the torque from the SI cylinder 18 is increased to be higher than the torque before the combined operation control, so as to effectively improve the fuel efficiency of the engine as a whole. In this case, although the torque from the CI cylinder 18 is the same as or lower than the requested torque of the engine 1, since the torque from the SI cylinder 18 exceeds the requested torque, the engine as a whole can suitably satisfy the requested torque.

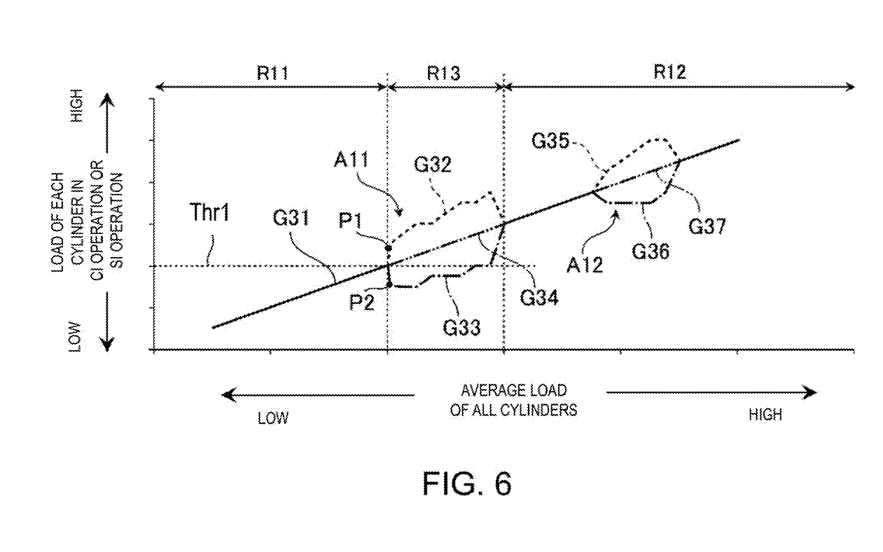

Next, the combined operation control of this embodiment is described more in detail with reference to FIG. 6. In FIG. 6, a horizontal axis indicates, in charts G31, G34, and G37, an average of loads of the plurality of cylinders 18 (i.e., an average load of the engine as a whole, and corresponds to the requested load), and a vertical axis indicates, in charts G32, G33, G35, and G36, the load of each cylinder 18 performing one of the CI and SI operations. Note that each load illustrated in FIG. 6 uniquely corresponds to torque (same below).

As illustrated in FIG. 6, within the first operating range R11, the PCM 10 causes all the cylinders 18 to perform the CI operation, and when the engine load increases and the operating range shifts from the first operating range R11 to the third operating range R13, as indicated by an arrow A11, the PCM 10 causes one or some of all the cylinders 18 to perform the CI operation and the rest of all the cylinders 18 to perform the SI operation. In the example of FIG. 6, with the four-cylinder engine, the PCM 10 causes predetermined two of the cylinders 18 to perform the CI operation and the other two cylinders 18 to perform the SI operation. In this case, the PCM 10 causes the predetermined two of the four cylinders 18 which have been performing the CI operation within the first operating range R11 to continue the CI operation, and causes the other two cylinders 18 to switch from the CI operation to the SI operation.

When the four cylinders 18 operate in a predetermined combustion order (corresponding to an ignition order), the PCM 10 preferably causes the CI cylinders 18 and the SI cylinders 18 to alternately perform the combustion, i.e., the CI combustion→the SI combustion→the CI combustion→the SI combustion . . . . For example, in a case where the combustion is performed in the order of the first cylinder→the third cylinder→the fourth cylinder→the second cylinder, or the order of the first cylinder→the second cylinder→the fourth cylinder→the third cylinder, the PCM 10 causes the first and fourth cylinders to perform one of the CI and SI operations and causes the second and third cylinders to perform the other one of the CI and SI operations. In this manner, engine vibration caused by a difference in torque between the SI and the CI cylinders 18 is reduced. In other words, a cycle of switching the torque of the SI cylinder 18 and the torque of the CI cylinder 18 therebetween is designed to be short so that the engine vibration is less easily felt.

More specifically, in each SI cylinder 18, as indicated by the chart G32, the PCM 10 increases the load of the SI cylinder 18 near the boundary between the first and third operating ranges R11 and R13 in the substantially stepwise fashion, greatly increases the load of the SI cylinder 18 after crossing the boundary, and then reduces near the boundary between the third and second operating ranges R13 and R12 in the substantially stepwise fashion. On the other hand, in each CI cylinder 18, as indicated by the chart G33, the PCM 10 reduces the load of the CI cylinder 18 near the boundary between the first and third operating ranges R11 and R13 in the substantially stepwise fashion, and gradually increases the load of the CI cylinder 18 after crossing the boundary. Then, when the load of the CI cylinder 18 exceeds a load threshold Thr1 defined in consideration of the combustion noise, the controllability of the ignition timing, etc. in relation to the CI operation, the PCM 10 switches the combustion mode from the CI operation to the SI operation to increase the load in a substantially stepwise fashion. By performing the SI and CI operations as indicated by the charts G32 and G33 as above, the high fuel efficiency in the CI operation can be applied while securing the combustion noise reduction, the controllability of the ignition timing, etc. in the CI operation, and additionally, the fuel efficiency of the engine as a whole can suitably be improved by an effect of the SI operation.

Note that the PCM 10 causes the loads of all the cylinders 18 to be even at the boundary between the third and second operating ranges R13 and R12. In other words, the PCM 10 causes the load of each cylinder 18 indicated by the chart G32 to be the same as that of each cylinder 18 indicated by the chart G33. Thus, all the cylinders 18 of the engine 1 perform the SI operation at the same load within the second operating range R12.

Moreover, when performing the SI and CI operations as described above, the PCM 10 causes the average value of the loads of the SI and CI cylinders 18 to match with the load indicated by the chart G34 which is an extension of the chart G31. In this manner, the average load (average torque) of the loads (torques) of the SI and CI cylinders 18 matches with the requested load (requested torque). Further, within the third operating range R13, the PCM 10 causes all the SI and CI cylinders 18 to operate at a theoretical air-fuel ratio (λ=1). Although an air-fuel ratio is normally set to be lean especially in the CI operation, at least within the third operating range R13, the CI operation is performed at the theoretical air-fuel ratio. In this manner, the air-fuel ratio of the exhaust gas discharged from any of the SI and CI cylinders 18 becomes the theoretical ratio, and by supplying such exhaust gas at the theoretical air-fuel ratio to the catalysts 41 and 42, which include the three-way catalysts, NOₓ contained within the exhaust gas discharged from each SI cylinder 18 is suitably purified by the catalysts 41 and 42.

Next, within the second operating range R12, the PCM 10 basically causes all the cylinders 18 to perform the SI operation at the same load. Note that within a load range indicated by an arrow Al2, the PCM 10 increases the loads of two of all the cylinders 18 performing the SI operation to be higher than the requested load (see the chart G35), and reduces the loads of the other two cylinders 18 to be lower than the requested load (see the chart G36). Also in this case, the PCM 10 causes an average value of the loads of the two SI cylinders 18 of which loads are increased and the loads of the other two SI cylinders 18 of which loads are reduced, to match with the load indicated by the chart G37 which is an extension of the chart G31 (i.e., match with the requested load).

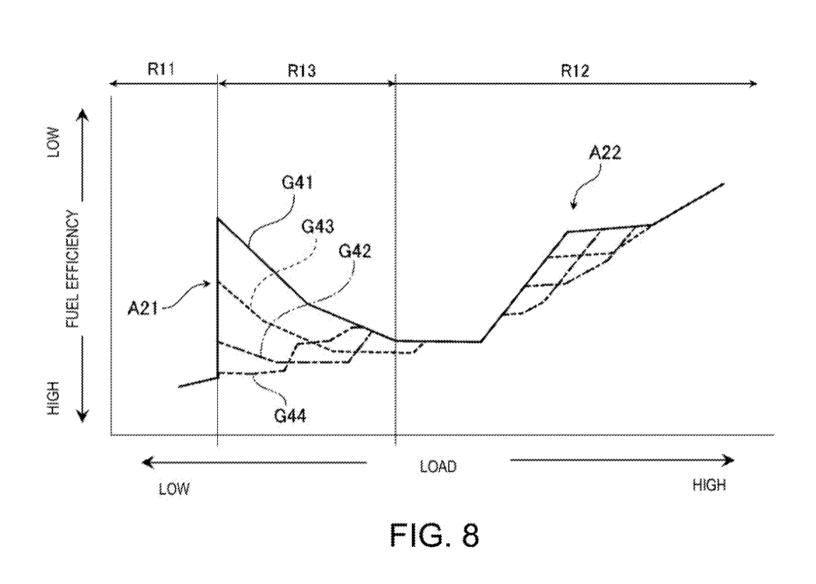

Note that within the load range indicated by the arrow Al2, as illustrated in FIG. 8 for which a description is given later, since the fuel efficiency degrades if all the cylinders 18 perform the SI operation at the same load, to improve the fuel efficiency in the SI operation, the load of each cylinder 18 is changed as described above.

Further, in the above description with reference to FIG. 6, the control for the case where the requested load of the engine 1 is increased and the operating range shifts from the first operating range R11→the third operating range R13→the second operating range R12 is described; however, such a control is also executed in a case where the requested load of the engine 1 is reduced and the operating range shifts from the second operating range R12→the third operating range R13→the first operating range R11.

Moreover, in achieving the CI operation and the SI operation as illustrated in FIG. 6, the PCM 10 controls the injectors 67, the ignition plugs 25, the VVT 72 and the VVL 74 on the intake side, the VVT 75 and the VVL 71 on the exhaust side, etc., per cylinder 18. The specific contents of the control are described in the section [Operating Range] above.

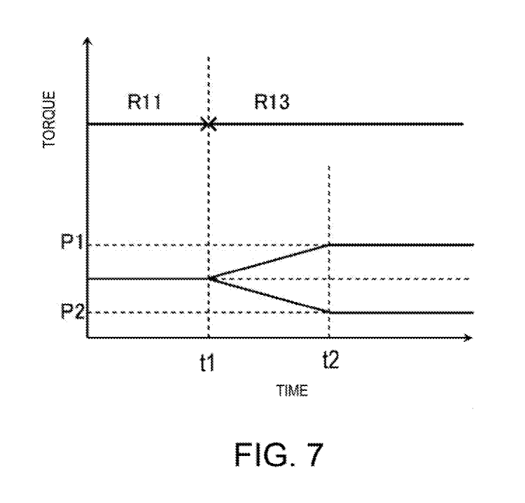

Here, a case where the requested load is slightly increased from a highest load within the first operating range R11 and the operating range shifts to the third operating range R13 is described with reference to FIG. 7 in addition to FIG. 6. In FIGS. 6 and 7, a reference character P1 indicates a final requested torque to be generated by the SI cylinder 18, and a reference character P2 indicates a final requested torque to be generated by the CI cylinder 18 so as to optimize the fuel efficiency at a lowest load within the third operating range R13. These torques P1 and P2 are achieved by a stepwise change from the highest load within the first operating range R11. In this case, as illustrated in FIG. 7, from a time point t1 to a time point t2, the PCM 10 gradually reduces the torque from the CI cylinder 18 to the torque P2, whereas, in order to keep the average load of the engine 1 at the lowest load within the third operating range R13, the PCM 10 gradually increases the torque from the SI cylinder 18 to the torque P1 accordingly.

Next, the fuel efficiency in the case where the combined operation control of this embodiment is executed is described with reference to FIG. 8. In FIG. 8, a horizontal axis indicates the load and a vertical axis indicates the fuel efficiency.

In FIG. 8, a chart G41 indicates the fuel efficiency in a case where the four-cylinder engine is applied and all the cylinders 18 are operated in the same combustion mode. Specifically, the chart G41 indicates the fuel efficiency in a case where all the cylinders 18 perform the CI operation within the first operating range R11, and all the cylinders 18 perform the SI operation within the third and second operating ranges R13 and R12. Note that the chart G41 indicates the fuel efficiency of a comparative example of this embodiment, and each of charts G42, G43, and G44 (described later) indicates the fuel efficiency of this embodiment.

The chart G42 indicates the fuel efficiency in a case where the four-cylinder engine is applied and a certain pair of the cylinders 18 operate in a different combustion mode from the other pair of the cylinders 18. Specifically, the chart G42 indicates the fuel efficiency in a case where, within the third operating range R13, one of the pairs of the cylinders 18 performs the CI operation and the other pair performs the SI operation (see an arrow A21), and, within a load range of the second operating range R12 as indicated by an arrow A22, all the cylinders 18 perform the SI operation such that the loads of one of the pair of the cylinders 18 are reduced and the loads of the other pair are increased.

The chart G43 indicates the fuel efficiency in a case where the four-cylinder engine is applied and a certain one of the cylinders 18 operates in a different combustion mode from the other three cylinders 18. Specifically, the chart G43 indicates the fuel efficiency in a case where, within the third operating range R13, the one of the cylinders 18 performs the CI operation and the other three cylinders 18 perform the SI operation (see the arrow A21), and, within the load range of the second operating range R12 as indicated by the arrow A22, all the cylinders 18 perform the SI operation such that the load of the one of the cylinders 18 is reduced and the loads of the other three cylinders 18 are increased.

The chart G44 indicates the fuel efficiency in a case where the four-cylinder engine is applied and a certain three of the cylinders 18 operate in a different combustion mode from the other cylinder 18. Specifically, the chart G44 indicates the fuel efficiency in a case where, within the third operating range R13, the three of the cylinders 18 perform the CI operation and the other cylinder 18 performs the SI operation (see the arrow A21), and, within the load range of the second operating range R12 as indicated by the arrow A22, all the cylinders 18 perform the SI operation such that the loads of the three of the cylinders 18 are reduced and the load of the other cylinder 18 is increased.

As it can be understood from FIG. 8, within the third operating range R13, in the case where all the cylinders 18 operate in the same combustion mode, in other words, all the cylinders 18 perform the SI operation, the fuel efficiency degrades (see the chart G41), whereas in the case where the combustion mode is varied among the cylinders 18, in other words, one or some of the cylinders 18 perform the CI operation and the rest of the cylinders 18 perform the SI operation, the fuel efficiency is improved (see the charts G42, G43, and G44). It can also be understood that within the load range of the second operating range R12 indicated by the arrow A22, although the fuel efficiency degrades if all the cylinders 18 perform the SI operation to gain the same load (see the chart G41), the fuel efficiency is improved when all the cylinders 18 perform the SI operation such that the one or some of the cylinders 18 are increased in load and the rest of the cylinders 18 are reduced in load (see the charts G42, G43, and G44).

### Control Example

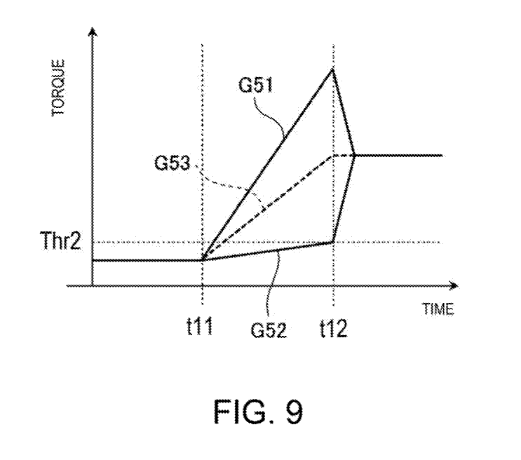

Next, various specific examples of the combined operation control of this embodiment are described with reference to FIGS. 9, 10, and 11. FIGS. 9, 10, and 11 are time charts illustrating first, second and third examples of the combined operation control of this embodiment, respectively. In FIGS. 9, 10, and 11, each horizontal axis indicates time and each vertical axis indicates torque (torque in each vertical axis uniquely corresponds to load).

Note that the control examples of FIGS. 9 to 11 are performed to change the torque of each CI cylinder 18 as gradually as possible, swiftly change the torque of the engine as a whole (average torque), etc. when changing the combustion phase of the engine 1 due to a change of the requested torque (requested load). Such a control is basically executed corresponding to the requested load based on the first to third operating ranges R11 to R13 illustrated in FIG. 3, and in some cases, the control may be executed regardless of being within any of the first to third operating ranges R11 to R13. For example, within the first operating range R11, one or some of the cylinders 18 performing the CI operation may be switched to perform the SI operation so as to swiftly change the torque of the engine as a whole while changing the torque of the CI cylinder 18 as gradually as possible.

As illustrated in FIGS. 9 to 11, the PCM 10 causes all the cylinders 18 to perform the CI operation up to a time point t11, and from the time point t11, the PCM 10 performs the combined operation control according to the increase of the requested torque (i.e., an acceleration request issued in response to depression of the acceleration pedal). In other words, at the time point t11, the PCM 10 switches the combustion mode of the one or some of all the cylinders 18 from the CI operation to the SI operation and keeps the combustion mode of the rest of the cylinders 18 as the CI operation.

In the first example, as illustrated in FIG. 9, from the time point t11, the PCM 10 greatly increases the torque of each SI cylinder 18 (see the chart G51) and gradually increases the torque of each CI cylinder 18 to secure the controllability of the combustion phase (see the chart G52). Further, after the time point t11, the PCM 10 causes the average torque of the torques of the SI and CI cylinders 18 to match with the requested torque (see the chart G53). Then, the torque of the CI cylinder 18 is gradually increased, and as a result, at a time point t12, the torque of the CI cylinder 18 reaches a torque threshold Thr2 corresponding to the above-described load threshold Thr1 (the load defined in consideration of the combustion noise, the controllability of the ignition timing, etc. in relation to the CI operation). At this time point t12, the PCM 10 switches the combustion mode of the CI cylinder 18 to the SI operation and increases the torque thereof in a substantially stepwise fashion, whereas regarding the SI cylinder 18 performing the SI operation before the time point t12, the PCM 10 reduces the torque in a substantially stepwise fashion to cause the torques of all the cylinders 18 to be even immediately after the time point t12.

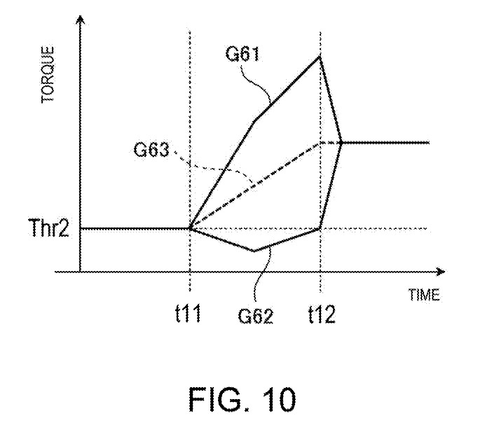

In the second example, as illustrated in FIG. 10, from the time point t11, the PCM 10 greatly increases the torque of each SI cylinder 18 (see the chart G61) and gradually reduces the torque of each CI cylinder 18 (see the chart G62). This is because, in the second example, different from the first example, the torque generated while all the cylinders 18 perform the CI operation, already reached the torque threshold Thr2 before the time point t11, and therefore, it is not suitable to increase the torque of the CI cylinder 18 from the time point t11. For this reason, in the second example, from the time point t11, the PCM 10 gradually reduces the torque of the CI cylinder 18 to a certain extent, and then gradually increases it. By reducing the torque of the CI cylinder 18 once, the fuel efficiency can be improved. Further, after the time point t11, the PCM 10 causes the average torque of the torques of the SI and CI cylinders 18 to match with the requested torque (see the chart G63). Then, the torque of the CI cylinder 18 is gradually increased, and as a result, at the time point t12, the torque of the CI cylinder 18 reaches the torque threshold Thr2. At this time point t12, the PCM 10 switches the combustion mode of the CI cylinder 18 to the SI operation and increases the torque thereof in a substantially stepwise fashion, whereas regarding the SI cylinder 18 performing the SI operation before the time point t12, the PCM 10 reduces the torque in a substantially stepwise fashion to cause the torques of all the cylinders 18 to be even immediately after the time point t12.

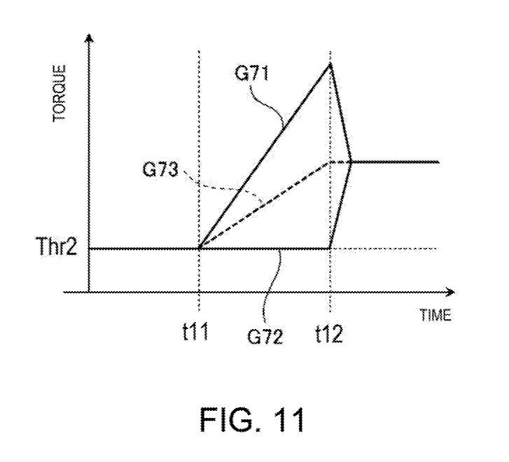

In the third example, as illustrated in FIG. 11, from the time point t11, the PCM 10 greatly increases the torque of each SI cylinder 18 (see the chart G71) and fixes the torque of each CI cylinder 18 (see the chart G72). In the third example, similar to the second example, the torque generated while all the cylinders 18 perform the CI operation, already reached the torque threshold Thr2 before the time point t11; however, different from the second example, the torque of the CI cylinder 18 is fixed without being reduced, in other words, the torque of the CI cylinder 18 is kept at the torque threshold Thr2. Further, after the time point t11, the PCM 10 causes the average torque of the torques of the SI and CI cylinders 18 to match with the requested torque (see the chart G73). Then, at the time point t12, the PCM 10 switches the combustion mode of the CI cylinder 18 to the SI operation and increases the torque thereof in a substantially stepwise fashion, whereas regarding the SI cylinder 18 performing the SI operation before the time point t12, the PCM 10 reduces the torque in a substantially stepwise fashion to cause the torques of all the cylinders 18 to be even immediately after the time point t12.

### Operations and Effects

Next, the operations and effects of the control apparatus of the engine according to this embodiment are described.

According to this embodiment, the third operating range R13 where the engine load is above the first operating range R11 and below the second operating range R12 (see FIG. 3) is defined, and within this third operating range R13, the combined operation control in which one or some of all the cylinders 18 perform the CI operation and the rest of all the cylinders 18 perform the SI operation is executed, and the change rate of the torque from the CI cylinder 18 is reduced to be lower than that of the torque from the SI cylinder 18 (see FIG. 6, etc.).

According to this embodiment, within the third operating range R13, the one or some of all the cylinders 18 perform the CI operation to gradually change the torque, and the rest of the cylinders 18 perform the SI operation to greatly change the torque. Therefore, the fuel efficiency can be improved while satisfying the requested torque.

Specifically, normally the fuel efficiency degrades if all the cylinders 18 perform the SI operation within the third operating range R13 (medium-low load range). However, since the one or some of the cylinders 18 perform the CI operation within the third operating range R13 and gradually change the torque, by greatly changing the torque of each of the rest of the cylinders 18 for performing the SI operation so as to satisfy the requested torque, the torque at which the high fuel efficiency is obtained by the SI operation can swiftly be applied from the SI cylinder 18. For example, by greatly increasing the torque of the SI cylinder 18, the load can swiftly reach the medium-high load range where the high fuel efficiency is obtained by the SI operation. Therefore, according to this embodiment, the fuel efficiency in the SI operation performed within the third operating range R13 can be improved.

On the other hand, normally it is not suitable to cause all the cylinders 18 to perform the CI operation within the third operating range R13. However, since the rest of the cylinders 18 perform the SI operation within the third operating range R13 and greatly change the torque as described above, by gradually changing the torque of each of the one or some of the cylinders 18 for performing the CI operation so as to satisfy the requested torque, the suitable CI operation in which the combustion noise reduction, the controllability of the igniting timing, etc. are secured, can be achieved. Thus, within the third operating range R13, the high fuel efficiency in the CI operation can suitably be obtained.

Thus, according to this embodiment, by performing both the CI and SI operations within the third operating range R13 and suitably controlling the torques generated therein, the fuel efficiency of the engine as a whole can be improved while satisfying the requested torque.

Particularly, according to this embodiment, the torque from the CI cylinder 18 is caused to be the same as or lower than the torque before the control, and the torque from the SI cylinder 18 is increased to be higher than the torque before the control (see FIG. 6, etc.). Therefore, the fuel efficiency of the engine as a whole can effectively be improved while satisfying the requested torque.

Further, according to this embodiment, the torque from the CI cylinder 18 is substantially fixed in a period around the timing of executing the control (e.g., see FIG. 11). Therefore, during the combined operation control, the controllability of the combustion phase can suitably be secured.

Further, according to this embodiment, all the CI and SI cylinders 18 perform the combustion at the theoretical air-fuel ratio (λ=1). Therefore, the exhaust gas from any of the SI and CI cylinders 18 achieves the theoretical air-fuel ratio, and the exhaust gas at the theoretical air-fuel ratio is supplied to the catalysts 41 and 42, which include the three-way catalysts, and NOₓ contained within the exhaust gas discharged from the SI cylinder 18 can suitably be purified by the catalysts 41 and 42.

Further, according to this embodiment, when the plurality of cylinders 18 of the engine 1 are operated in the predetermined combustion order, the CI and SI cylinders 18 alternately perform the combustion. Therefore, the engine vibration caused by the difference between the torque of the CI cylinder 18 and the torque of the SI cylinder 18 can be reduced. Specifically, the cycle of switching the torque of the SI cylinder 18 and the torque of the CI cylinder 18 therebetween is designed to be short so that the engine vibration is less easily felt.

Further, according to this embodiment, the average torque of the torque of the CI cylinder 18 and the torque of the SI cylinder 18 is matched with the requested torque corresponding to the requested load of the engine 1. Therefore, the requested torque can reliably be satisfied during the combined operation control.

### Modifications

Hereinafter, modifications of this embodiment are described.

In this embodiment, the case where the spark-ignition operation (SI operation) using the ignition plug 25 is described as one example of the forced-ignition operation; however, the present invention is also applicable to a forced-ignition operation using a laser ignition plug.

Further, in this embodiment, when the plurality of cylinders 18 of the engine 1 are operated in the predetermined combustion order, the CI and SI cylinders 18 alternately perform the combustion. In this case, the plurality of cylinders 18 which are caused to perform one of the CI operation and the SI operation by the combined operation control change depending on the timing of starting the combined operation control, in other words, depending on the cylinder 18 (cylinder number) to combust first after the timing of starting the combined operation control, etc.

In another example, the cylinders 18 which are caused to perform one of the CI operation and the SI operation by the combined operation control may be fixed. In this case, the exhaust emission control device, which includes three-way catalysts, may be divided into two catalysts, so that only the exhaust gas from the SI cylinder 18 flows into one of the catalysts and only the exhaust gas from the CI cylinder 18 flows into the other catalyst. Thus, by performing the SI operation at the theoretical air-fuel ratio, NOₓ contained within the exhaust gas discharged from the SI cylinder 18 can suitably be purified by one of the divided catalysts without receiving influence of the air-fuel ratio of the exhaust gas from the CI cylinder 18.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1 Engine
10 PCM
18 Cylinder
21 Intake Valve
22 Exhaust Valve
25 Ignition Plug
67 Injector
71, 74 VVL
72, 75 VVT
R11 First Operating Range
R12 Second Operating Range
R13 Third Operating Range

What is claimed is:

1. A control apparatus that is applied to a gasoline engine including a plurality of cylinders, comprising:
a controller for controlling the engine to perform a compression self-ignition operation within a first operating range of the engine where an engine load is lower than a predetermined value, and perform a forced-ignition operation within a second operating range of the engine where the engine load is above the first operating range, the compression self-ignition operation being an operation in which the engine is operated by compressing a mixture gas containing fuel to self-ignite, the forced-ignition operation being an operation in which the engine is operated by forcibly igniting the mixture gas,
wherein within a third operating range of the engine where the engine load is above the first operating range and below the second operating range, the controller executes a combined operation control in which a first cylinder performs the compression self-ignition operation and a second cylinder performs the forced-ignition operation, and the controller causes a change rate of a torque generated by the first cylinder to be lower than a change rate of a torque generated by the second cylinder, each of the change rates being taken in relation to a change of a requested load of the engine, the first cylinder being one or some of the plurality of cylinders, the second cylinder being in a remainder of the plurality of cylinders.

2. The control apparatus of claim 1, wherein the controller causes the torque generated by the first cylinder to be the same as or lower than a torque thereof before the combined operation control, and the controller increases the torque generated by the second cylinder to be higher than a torque thereof before the combined operation control.

3. The control apparatus of claim 1, wherein in a period around the timing of executing the combined operation control, the controller substantially fixes the torque generated by the first cylinder.

4. The control apparatus of claim 1, wherein the controller causes both the first and second cylinders to perform combustion at a theoretical air-fuel ratio.

5. The control apparatus of claim 1, wherein in a case where the controller causes the plurality of cylinders of the engine to operate in a predetermined combustion order, the controller causes the first and second cylinders to alternately perform combustion.

6. The control apparatus of claim 1, wherein the controller causes an average torque of the torque generated by the first cylinder and the torque generated by the second cylinder to match with a requested torque corresponding to the requested load of the engine.
